(19) United States
(12) Patent Application Publication
(10) Pub. No.: US 2024/0262242 A1
(43) Pub. Date: Aug. 8, 2024

(54) RANGE ESTIMATION FOR BATTERY ELECTRIC VEHICLES

(71) Applicant: Garrett Transportation I Inc., Torrance, CA (US)

(72) Inventor: Tomas Poloni, Malinovo (SK)

(21) Appl. No.: 18/164,424

(22) Filed: Feb. 3, 2023

(51) Int. Cl. B60L 58/12; G01C 21/34

(52) U.S. Cl. CPC B60L 58/12; G01C 21/3469; B60L 2240/12; B60L 2240/60; B60L 2240/70

(57) ABSTRACT

Methods and systems for estimating driving range for an electric vehicle. Each of Kalman Filter-based and receding horizon-based approaches to estimating driving range and providing driving range data to a driver of a vehicle are illustrated. Approaches configured for use when a destination is not known as well as when a destination is known are illustrated.

### BACKGROUND

Limited driving range, long charging time, and, at least in some regions, limited charging infrastructure each make range anxiety an issue for many drivers of electric vehicles (EVs). Some drivers reserve a buffer of up to 20% of battery capacity due to range anxiety. Rather than recharging in response to an EOR alert (which typically means 20% of battery capacity remains in some EV vehicles), some drivers try to avoid the EOR alert entirely, even on longer trips. Issues related to range anxiety may limit EV acceptance and/or popularity, and may also lead to sub-optimal operating decisions. For example, battery aging may be accelerated by short charging cycles.

Improvements to EV range estimation are challenging due to uncertainties in future driving conditions, including driving patterns, traffic conditions, environmental factors such as temperature, wind, and precipitation, as well as battery state including non-linearity and aging factors. The relationship between remaining available battery capacity and the measured circuit voltage from the EV battery may be non-linear. During operation, only a loaded battery voltage measurement may be available. In many EV installations, current drawn from the EV battery is monitored, as well as current delivered to the EV battery during recharging to determine remaining available charge on the battery, however, measurement error can arise, and the battery itself is subject to self-discharge. Translating remaining available battery capacity to a distance/range is not a simple task in view of factors that affect such a translation, including road features (slope, curvature), environmental factors, driver decisions (more or less aggressive driving), and secondary current draw due to cabin comfort and infotainment demands. New and alternative methods, controllers and systems for range estimation in electric vehicles are desired.

### OVERVIEW

The present inventors have recognized, among other things, that a problem to be solved is the need for new and/or alternative methods, controllers and systems for range estimation in electric vehicles.

A first illustrative and non-limiting examples takes the form of a method of generating estimates of end of range for an electric vehicle, comprising: obtaining a set of data for a previous trip of the electric vehicle; estimating a set of model parameters for reduction of battery capacity relative to distance travelled, from a starting battery capacity to an end of range battery capacity using the previous trip data; calculating an error covariance matrix for the set of model parameters using the previous trip data; for a new trip, applying the set of model parameters and error covariance matrix to generate an estimated end of range distance; and displaying the estimated end of range distance to a driver of the vehicle, wherein the displayed prediction is updated as the new trip progresses.

Additionally or alternatively, the method may include recording distance, speed, and battery parameters during the new trip for use in performing the estimating and calculating steps for a subsequent trip. Additionally or alternatively, the displayed prediction is updated as the new trip progresses by: determining actual driven distance and change in battery state of charge (SOC) during the new trip; using the actual driven distance and change in battery SOC during the new trip to update the set of model parameters and the error covariance matrix; reapplying the updated set of model parameters and the updated error covariance matrix to generate an updated estimated end of range distance; and displaying the updated estimated end of range distance to the driver of the vehicle.

Additionally or alternatively, the error covariance matrix is calculated with a Kalman filter operating on the set of data for the previous trip of the electric vehicle, and wherein the step of using the actual driven distance and change in battery SOC during the new trip to update the set of model parameters and the error covariance matrix comprises updating the model parameters in a discrete time model by calculating and adding to each of the model parameters a process noise of the respective parameter, as calculated by the Kalman filter. Additionally or alternatively, the error covariance matrix is calculated with a Kalman filter operating on the set of data for the previous trip of the electric vehicle.

Additionally or alternatively, the set of data for the previous trip of the electric vehicle is for a previous trip having at least a minimum distance traveled or a minimum duration of travel. Additionally or alternatively, the step of applying the set of model parameters and error covariance matrix to generate an estimated end of range distance for the new trip is performed without a destination known to a control apparatus of the electric vehicle. Additionally or alternatively, the set of model parameters are the parameters a and b in the following formula: Distance=a*SOC_{U}+b, wherein SOC_{U} is a usable battery charge at a start of the new trip.

Another illustrative and non-limiting example takes the form of a method of generating estimates of end of range for an electric vehicle, comprising: obtaining a set of data for a previous trip of the electric vehicle; estimating a set of model parameters for reduction of battery capacity relative to distance travelled, from a starting battery capacity to an end of range battery capacity using the previous trip data, by entering treating the previous trip data as inputs to a moving horizon observer; for a new trip, applying the set of model parameters to generate an estimated end of range distance; and displaying the estimated end of range distance to a driver of the vehicle, wherein the displayed prediction is updated as the new trip progresses by obtaining new data from the new trip, and entering the new data in the moving horizon observer while removing oldest data from the moving horizon observer.

Additionally or alternatively, the set of data for the previous trip of the electric vehicle is for a previous trip having at least a minimum distance traveled or a minimum duration of travel. Additionally or alternatively, the set of model parameters are the parameters a and b in the following formula: Distance=a*SOC_{U}+b, wherein SOC_{U} is a usable battery charge at a start of the new trip. Additionally or alternatively, the method may further include recording distance, speed, and battery parameters during the new trip for use in performing the estimating and calculating steps for a subsequent trip.

Another illustrative and non-limiting example takes the form of a method of generating updated estimates of end of range for an electric vehicle, comprising: receiving a destination for a current trip of the vehicle; in a digital twin simulation: generating a speed profile for the vehicle to reach the destination using a model of the vehicle, and road data for a path between a current position of the vehicle and the destination; generating a battery charge consumption using a battery model for the vehicle to determine expected charge consumption to reach the destination or an end of range position; and setting an end of range (EOR) reference and battery state of charge (SOC) EOR value; communicating the EOR reference and the battery SOC EOR value to the vehicle from the digital twin; as the vehicle traverses the path: collecting actual distance traveled and battery state of SOC measurements; fusing the EOR reference, the battery SOC EOR value, the battery SOC measurement, and the actual distance travelled to update a model relating battery SOC to distance travelled; estimating EOR for the vehicle in the current trip; and displaying the estimated EOR for the vehicle in the current trip to a driver of the vehicle.

Additionally or alternatively, the fusing step is performed in a Kalman filter having an R matrix, a Q matrix, and an error covariance matrix, by: constructing a first model using the EOR reference and the battery SOC EOR value as: y_{1,k}=a*SOC_{EOR}+b+v_{1,k}, wherein y_{1,k} is the EOR reference, SOC_{EOR} is the battery SOC at EOR, and v_{1,k} is a white noise defined by a variance of the Kalman filter R matrix, and a and b are model parameters; pairing the first model with a second model of the form: y_{2,k}=a*SOCₖ+b+v_{2,k}, wherein y_{2,k} is the actually driven distance at a sample, k, SOCₖ, is the battery SOC at sample k, and v_{2,k} is a white noise defined by a variance of the Kalman filter R matrix.

Additionally or alternatively, the model parameters a and b are treated as constants and are updated from one sample to a next sample using formulas given by: pₖ=pₖ₋₁+w_{p,k-1}, bₖ=bₖ₋₁+w_{b,k-1}, wherein w_{p,k-1} is the process noise of the a parameter and w_{b,k-1} is the process noise of the b parameters, each given by the Kalman filter Q matrix. Additionally or alternatively, the method may also include updating the estimated EOR for the vehicle in the current trip using the updated model parameters, and displaying to a driver of the vehicle an updated estimated EOR at least once. Additionally or alternatively, the steps of collecting, fusing, estimating and displaying are performed repeatedly at sample times as the vehicle traverses the path.

Additionally or alternatively, the digital twin uses traffic data in addition to road data to generate the speed profile, and the collecting, fusing, estimating and displaying steps are performed without obtaining or using traffic or road data. Additionally or alternatively, the set of data for the previous trip of the electric vehicle is for a previous trip having at least a minimum distance traveled or a minimum duration of travel. Additionally or alternatively, the digital twin may be calculated in a fleet monitor or data processing center remote from the electric vehicle.

Additional illustrative examples include controllers configured for performing the above methods and electric vehicles, such as that shown in FIG. 1, having such controllers.

This overview is intended to provide an introduction to the subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an electric vehicle in simplified block form;

FIGS. 2-4 show in block and graphic forms a first illustrative example for a trip in which a destination is not defined;

FIGS. 5-6 and 7A-7B show in block and graphic forms a second illustrative example for a trip in which a destination is defined; and

FIG. 8 illustrates an approach using a moving horizon observer.

### DETAILED DESCRIPTION

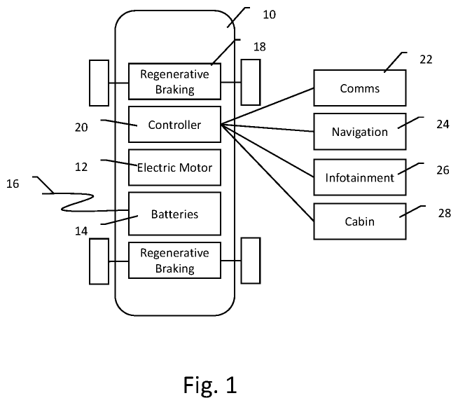

FIG. 1 shows an electric vehicle in simplified block form. The skilled person will recognize that the following discussion may not necessarily describe every feature that would be present in the vehicle 10, to avoid excessive exposition of features that are not necessary to understanding the following examples.

The vehicle 10 is characterized by an electric motor 12 (or plural electric motors 12) that provide motive force to the vehicle 10, powered by batteries 14. The batteries 14 are rechargeable by connection 16 to an off-vehicle electricity source, as is known in the art, and may have any suitable chemistry and/or design. Batteries 14 may be associated with various secondary features, such as warming and/or cooling apparatuses to maintain suitable temperatures therein. Regenerative braking 18 may be provided, and serves to at least partly recharge the batteries 14 under suitable braking conditions.

A controller 20 is coupled to each of these blocks, and may further be linked to control blocks for communications 22, navigation 24, infotainment 26, and cabin 28. The controller 20 is configured for sending and receiving information as well as to provide and/or control power used by, for example, an air conditioning unit used for cooling the cabin 28, or other environmental controls for the cabin 28. The communications 22 may include any of satellite, cellular, Bluetooth, broadband, WiFi, and/or various other wireless communications circuits, antennae, receivers, transceivers, transmitters, etc., as desired. The communications 22 may allow the controller 20 to send and receive data relative to one or more internet, dedicated, and/or cloud-based data receiving and/or processing centers, such as a fleet monitor. In some examples that follow, the communications 22 may be used to upload and/or download data of various types. The navigation system 24 may store, retrieve, receive, and/or display various types of data including, for example and without limitation, weather/environmental data, road data including curvature, posted speed limits, and grade, as well as traffic data, as desired. The navigation system 24 may also be used to provide route instructions to a driver of the vehicle, and/or to provide a route for an autonomous drive controller to use. The navigation system 24 may include a global positioning system (GPS) device for determining and tracking position of the vehicle 10.

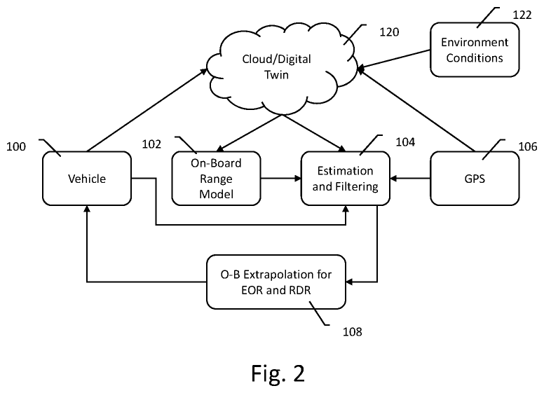

FIGS. 2-4 show in block and graphic forms a first illustrative example for a trip in which a destination is not defined. In this example, the vehicle has not received a defined destination from the driver, and so an overall road plan cannot be made. Here, the vehicle 100 communicates data regarding a previous trip, or trips, to the cloud 120 which includes a server/processor that hosts a digital twin that models the vehicle 100 and the components thereof that would be used to traverse a path to a destination.

A prior trip, as used herein may be a particular instance of driving the vehicle, or may instead be a prior instance of depletion of the vehicle battery to a selected degree. For example, if a driver makes multiple stops during a day out before returning home and recharging the vehicle battery, a “prior trip” may include all activity from the point of departure until return. If the battery is not recharged immediately, the “prior trip” may include all activity between a last battery recharging session and the battery recharging session that preceded the last battery recharging session. Other formulations and/or input limits may be used. For example, a “prior trip” may be a vehicle excursion that exceeds a minimum distance (10 to 100 kilometers, for example, or other distance) or duration (30 minutes to 3 hours, or other duration), as desired.

The prior trip data may include multiple measurements of battery utilization, including one or more reports of state of charge (SOC), such as reporting a battery SOC based on charge to and from the battery, and/or battery voltage readings, as desired. The prior trip data may include distance travelled during the prior trip. Typically both battery SOC data and distance travelled data are provided. Additional data, such as velocity, road grade, curvature, ambient conditions, and secondary current drain (such as due to cabin heating/cooling) may also be communicated.

The cloud based digital twin 120 is used to generate a model of battery SOC and driving distance, and extrapolates from the provided data to determine how far the vehicle could go if driven to the range limit of the battery by selecting a battery SOC for end-of-range (EOR). The battery SOC at the point of EOR can be referred to herein as the battery SOC_{EOR}, which can be a manufacturer or driver-determined battery SOC. Typically the range may be 15% to 30% of total battery SOC, with 20% in some illustrative examples. The driver may be provided with an option to select a larger or smaller % for the battery SOC_{EOR}, if desired.

In an example, the digital twin 120 uses a formula of the type shown in Equation 1 to relate the total available range to the battery SOC:

$$Distance = a * {SOC}_{U} + b \qquad ( 1 )$$

Where a and b are coefficients of the equation as explained further below, and “SOC_{U}” is the usable SOC at the start of the trip, for example, as shown in Equation 2:

$${SOC}_{U} = {SOC}_{ST} - {SOC}_{EOR} \qquad ( 2 )$$

Where SOC_{ST} is the state of charge at the start of the trip, which may be the maximum SOC if the battery is fully charged. Equation 1 is merely illustrative, other, more sophisticated and/or accurate models may be used instead, as desired. For example, available distance may include further terms using a square of actual or average vehicle speed, times a third coefficient. In some examples, coefficients a and b in Equation 1 may be determined using a best fit or least squares analysis based on prior trip data and/or initial settings for a and b. For example, with a new vehicle or new battery, a manufacturer may provide values for a and b based on manufacturer testing. As the vehicle and/or battery age, a and b can be updated over time. In some examples, a and b in Equation 1 are simply based on the last available trip data in a best fit manner.

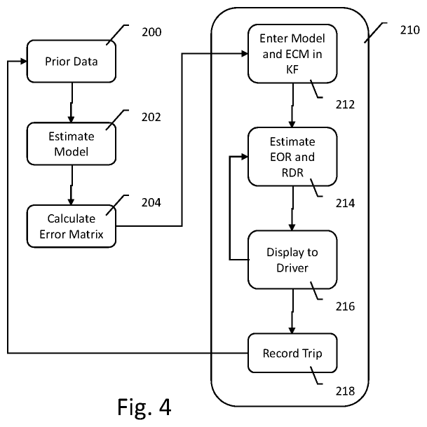

Turning to FIG. 4, operation using the digital twin 120 is illustrated. Using the communicated data from a previous trip 200, a recursive least-squares or Kalman filter algorithm is run to learn an error covariance matrix P for Equation (1). The result is both an estimated model 202, such as in Equation 1, and associated error covariance matrix 204.

Next, in the vehicle 210 and/or in online operations, the model and error covariance matrix are entered at 212, such as by downloading from the digital twin/cloud/remote server using the communications capabilities of the vehicle. At 214, for the new trip, a predicted EOR is then calculated along with the estimated remaining driving range (RDR). The RDR is calculated by subtracting actual driven distance from the EOR. The RDR is then displayed to the driver at 216. Trip data is recorded at 218, and used as prior trip data for a subsequent iteration of the method, as indicated by the arrow from block 218 to 200.

The method can be internally recursive as indicated with the return arrow from 216 to 214. In a simplest form, the RDR is updated as driving distance accumulates, without adjusting the original EOR estimate. In another example, current state measurements of the vehicle may be used to iteratively update the model that was downloaded, as new vehicle state data is accumulated. This may result in adjustments to the error covariance matrix and/or coefficients in the downloaded model. The EOR estimate can thus be tailored as the trip proceeds. The model parameters may be stored in the database and cloud-classified, and their initial values may be scheduled or the on-board computations based on location, weather conditions, and/or power demands. For example, Equation 1 above may be updated to adapt variables a and/or b to the actual data reflecting current vehicle state, ambient conditions and route data. Further, Equation 1 may be modified during a trip by monitoring charge drawn from the drive battery and tracking the distance travelled using such charge.

The initial state of the Kalman filter can be described by:

$$x = [ a ; b ] \qquad ( 3 )$$

Using Equation 1 above; suitable modification for other models/equations in place of Equation 1 may be used instead. The estimated covariance matrix, P, will be based on the digital twin's analysis of prior trip data. An estimated EOR and remaining driving range (RDR) result by extrapolating the Kalman filter model to the SOC_{EOR}. The lower prediction interval is then displayed to the driver through the human machine interface of the vehicle.

Returning to FIG. 2, the illustrative example of FIG. 4 can be augmented with various factors. For example, the cloud/digital twin may obtain environmental condition data 122, including for example and without limitation, data related to wind, temperature, and/or precipitation. In windy conditions, the vehicle can be assumed to be less efficient than would otherwise be the case, as more force may be needed to maintain velocity. In warm or very cold conditions, passenger cabin demands for heating or cooling may be greater, and energy needed to maintain the battery in an optimal performance range can change. In conditions with precipitation, the maximum vehicle velocity may be reduced, meaning that more energy will be needed over time to manage secondary functions in the vehicle as the trip may take more time than would otherwise be the case. GPS data 106 may also be obtained in the cloud 120, such as to provide a general understanding of likely drive type (urban or highway for example). Such factors may be used to classify and modify (schedule) coefficients such as in Equation 1, and/or to adjust the available charge as in Equation 2, as desired.

The cloud/digital twin 120 provides data to initialize an on-board range model 102 in the vehicle. Estimation and filtering operations are performed at 104, such as applying a Kalman filter to update the model and to provide output estimates. GPS data 106, or an on-board odometer, or any other suitable distance travelled technology, provides the distance driven as the vehicle moves. The estimation and filtering block 104 then provides an on-board extrapolation of EOR and RDR at 108. The RDR can then be displayed to the driver of the vehicle.

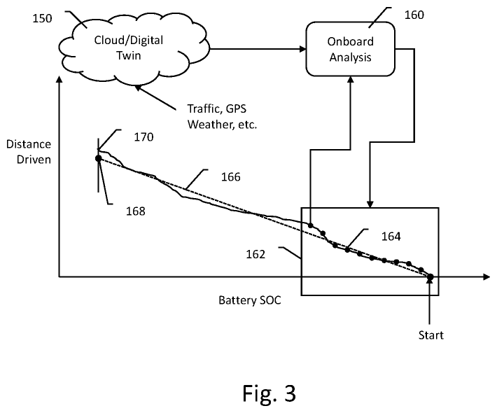

FIG. 3 shows a graphic form of the method. Here, the cloud digital twin 150, using for example traffic, GPS and/or weather data, provides the initial model by batch processing to the onboard analysis 160. A batch growing or receding window at 162 reflects ongoing data from a start point for the trip, with a plurality of observed data points 164. The range model extrapolation is shown at 166, tracking to the modeled EOR at 168, while the actual data proceeds to the actual EOR at 170. In the graphic portion, the lines for the distance driven and battery SOC should be understood as moving from right to left across the page and up the graph, such that, as the distance driven increases, the battery SOC decreases. As noted above, data is captured throughout the process for use in a subsequent trip.

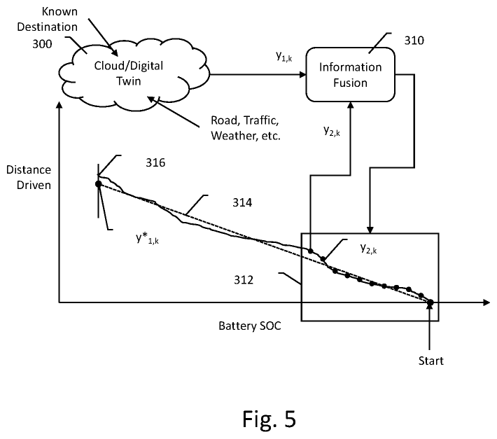

FIGS. 5-6 and 7A-7B show in block and graphic forms a second illustrative example for a trip in which a destination is defined. Starting in FIG. 5, here, the digital twin 300, which may be cloud based as noted, now receives a known destination, and can then use this to determine traffic, weather, and/or route/road data. The digital twin 300 is used to generate initial range model parameters, using for example a Kalman filter, and the model parameters and associated error data, such as an error covariance matrix if a Kalman filter is used, are then communicated to the vehicle.

In an example, the digital twin simulation may obtain/determine vehicle characteristics, such as but not limited to, vehicle mass, vehicle wind resistance, transmission type or other details, motor capabilities (power/current ratio for example), battery capacity and/or type, and secondary power uses in the vehicle, which may include battery temperature control, and cabin controls. A roadmap can be determined using GPS and/or map data, based on the known destination. A power profile can then be generated, such as by determining road characteristics (curvature, slope, prevailing/legal speed limits, traffic control data such as roundabouts, stop lights and stop signs, as well as existing or predicted traffic and/or weather information) to create a speed profile for the vehicle using a vehicle route and the road characteristics, and the power profile flows directly from the speed profile. The speed profile may be augmented using driver data or prior vehicle usage data uploaded from the vehicle, such as by reference to a prior similar (or same) trip. The speed profile may also be augmented using comfort information, such as by determining allowable speed range at locations where road curvature occurs.

Battery state of health and SOC data are then used to simulate the battery SOC throughout the route and to determine end of range based on the battery SOC at EOR. The digital twin simulation is provided to the vehicle, for information fusion 310 with the on-board EOR model, which may in turn be based on prior trip data or a stored EOR model in the vehicle.

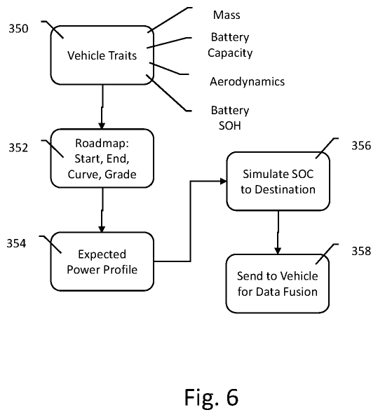

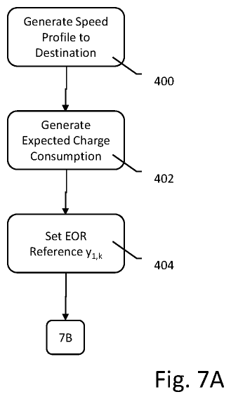

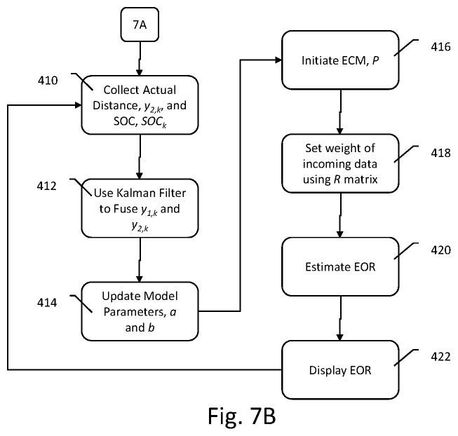

Turning to FIG. 6, in an example, a Kalman filter is used in the digital twin. The Kalman filter measurement models of actual driven range and EOR cloud reference can be given using the following equations:

$${y}_{1 , k} = a * {SOC}_{EOR} + b + {v}_{1 , k} \qquad ( 4 )$$

$${y}_{2 , k} = a * {SOC}_{k} + b + {v}_{2 , k} \qquad ( 5 )$$

Where y_{1,k} is the EOR cloud reference measurement provided by the digital twin, and y_{2,k} is the measurement of the actually driven distance at the current time, k, provided by the vehicle GPS or odometry. SOCₖ is the SOC measurement at the current time, k, and SOC_{EOR} is the SOC value at the EOR. The discrete time white noises are shown as v_{1,k} and v_{2,k}, defined by the variance in the Kalman filter R matrix. Model parameters a and b are treated as constants (except for process noise) and given in the discrete time model as:

$${a}_{k} = {a}_{k - 1} + {w}_{a , k - 1} \qquad ( 6 )$$

$${b}_{k} = {b}_{k - 1} + {w}_{b , k - 1} \qquad ( 7 )$$

Where w_{a,k-1} is the process noise of the a parameter, and w_{b,k-1} is the process noise of the b parameter, each given by the Kalman filter Q-matrix. FIGS. 7A-7B, below, illustrate the information fusion at block 310. In the batch growing or receding window 312, a number of data points are built as the vehicle progresses along the travel route, with the range model extrapolation shown at 314 to the estimated end of range, y*_{1,k}, which is based on the model fusion. The actual or true end of range is shown at 316. As the vehicle progresses on the route, the graphic again moves from right to left along the battery SOC (which is going down) and goes up with distance driven. Data fed back to the information fusion 310 from the window 312 may include, for example and without limitation, GPS and/or odometer data for vehicle speed, position and distance driven. Information fusion block 310 may also receive battery SOC data for continuing updating of the information fusion process.

FIG. 6 is illustrative of the digital twin process. The vehicle traits are gathered at 350. These may include vehicle weight/mass, battery capacity and/or type, aerodynamics and other data (such as tire, brake, differential, gearing/transmission) that affect vehicle motion and efficiency, and the battery state of health (SOH). The path to the destination and its details are then gathered at 352, including start and end points, road curvature and grade. Additionally in 352, road quality (pavement, pavement type, gravel), traffic, speed limits, prevailing traffic/travel speeds, travel controls, such as stoplights, roundabouts, stop signs, merges and splits that affect vehicle trajectory, and weather can also be integrated.

Block 354 shows that an expected power profile for the travel route is generated. Block 354 may include, as an intermediate point in the analysis, estimating a vehicle speed profile along the travel path using traffic data, legal speed limits, traffic controls, and vehicle comfort determinations using road type/curvature. Some examples for generating vehicle speed and/or power profiles along a route or path can be found in U.S. patent application Ser. No. 17/969,398, titled DRIVER AND LEAD VEHICLE PREDICTION MODEL, Ser. No. 17/969,359, titled HIERARCHICAL OPTIMAL CONTROLLER FOR PREDICTIVE POWER SPLIT, and/or Ser. No. 17/969,181, titled ENERGY EFFICIENT PREDICTIVE POWER SPLIT FOR HYBRID POWERTRAINS. Additional factors that may be considered in block 354 may include environmental issues, such as ambient temperature which can be expected to affect power demands for drive battery heating/cooling to maintain the battery in desired operating state, as well as passenger cabin demands. If the vehicle is used for freight passage, additional factors related to freight (load mass and any needed power consumption related to load such as heating/cooling factors) may be included when determining power profile needs, where the freight may affect the speed profile or the power needed to maintain speed, and/or require additional power usage to maintain freight at, for example, a desired temperature.

The digital twin then simulates battery SOC to the destination at 356. If needed, stops may be planned and accounted for in block 356. The simulation results are then sent to the vehicle for data fusion.

FIGS. 7A-7B show in block form an illustrative digital twin fusion process. Using the set destination, a speed profile to the destination can be calculated at 400 using the digital twin vehicle model, and taking into account road/route details such as road curvature, road grade, applicable limits for speed and other traffic controls, existing traffic conditions, and weather, as well as any known driver attributes such as the likely speed at which the driver will wish to proceed. Expected charge consumption along the route is then generated, as indicated at 402. The end of range reference is then set as y_{1,k}, where this determination is based on simulating the vehicle's progress toward the destination until an EOR value of the SOC (such as 20% to 30% of the maximum battery SOC) is reached. The process then moves to FIG. 7B.

At block 410, as the vehicle is driven, the system collects actual distance traveled, value y_{2,k}, and the battery SOC, SOCₖ. GPS or odometer data may be used to determine actual distance travelled, and battery SOC can be monitored by tracking current flowing from/to the battery over time, or by the use of other measurements. The model is then applied at 412, such as by using a Kalman filter or a moving horizon observer to fuse the EOR measurement y_{1,k} and the actual measured current range y_{2,k}. The data fusion will then be used to update the model parameters a and b, such as by the use of Equations 6 and 7 above. The Error Covariance Matrix, typically identified as a P matrix, of the Kalman filter can be initiated (for the first sample at least) or updated at indicated at 416. Incoming data weights are generated using the Kalman filter R matrix at 418. With by integrating the incoming data and updating the model parameters a and b, an EOR estimate is generated at 420 and displayed to the driver/user at 422. The method then iterates back to block 410, with k incremented to the next sample. Samples may be taken, for example, at intervals of 0.1 to 10 seconds, or more or less, as desired. An EOR estimate may be directly displayed from the analysis, or a smoothing/weighting function can be further applied so that the user is not presented with a continuously changing EOR estimate, though this smoothing function may also be provided by the incoming data weights generated at 418.

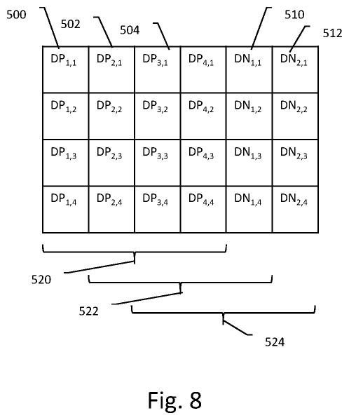

As noted, a moving horizon observer may be used instead of a Kalman filter. FIG. 8 provides an illustration. The moving horizon observer uses the batch of receding window data (instead of the current sample as the Kalman Filter does). The receding window utilizes the model predictive idea similarly to a model predictive controller. The moving horizon observer avoids the use of a state vector error covariance matrix (the P matrix), or any other historical information beyond the data window and the a priori state estimate and leads to a conceptually simple problem formulation and tuning parameters. Model parameters a and b (and any additional parameters, if a more sophisticated assessment is used) may be calculated using a least-squares minimization routine from a finite memory moving window of both current and historical measurement data.

In the illustration of FIG. 8, a chart of stored data is shown. Each data point can be Data for Previous trip (DP), or Data for New trip (DN), and has a first subscript corresponding to a time sample (1, 2, 3, 4), and a second subscript corresponding to a data type (again, 1, 2, 3, 4). The data types may be any of the data previously discussed, including charge usage or charge state of the battery, distance travelled (cumulative or in the time sample), as well as suitable acceleration, drag, non-propulsion current information, etc. as is suitable to a particular use. An initial data horizon is shown at 520, encompassing the prior trip data (a portion of such data or all of the prior trip data may be used). The data at 520 is used to generate a first set of model parameters, which may take the form of parameters a, b discussed previously. As new data is captured for the new trip, the oldest data from the prior trip exits the horizon, as shown by brackets 522 and 524. Thus the data are continuously updated, with the oldest data being discarded as new data comes in. The model parameters a, b can be recalculated repeatedly, and updated with the new trip.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls. The terms “a” or “an” are used, as is common in patent documents, to include one or more than one, independent of any other instances or usages of “at least one” or “one or more.” Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A method of generating estimates of end of range for an electric vehicle, comprising:
obtaining a set of data for a previous trip of the electric vehicle;
estimating a set of model parameters for reduction of battery capacity relative to distance travelled, from a starting battery capacity to an end of range battery capacity using the previous trip data;
calculating an error covariance matrix for the set of model parameters using the previous trip data;
for a new trip, applying the set of model parameters and error covariance matrix to generate an estimated end of range distance; and
displaying the estimated end of range distance to a driver of the vehicle,
wherein the displayed prediction is updated as the new trip progresses.

2. The method of claim 1, further comprising recording distance, speed, and battery parameters during the new trip for use in performing the estimating and calculating steps for a subsequent trip.

3. The method of claim 1, wherein the displayed prediction is updated as the new trip progresses by:
determining actual driven distance of the vehicle and change in battery state of charge (SOC) during the new trip;
using the actual driven distance and change in battery SOC during the new trip to update the set of model parameters and the error covariance matrix;
reapplying the updated set of model parameters and the updated error covariance matrix to generate an updated estimated end of range distance; and
displaying the updated estimated end of range distance to the driver of the vehicle.

4. The method of claim 3, wherein the error covariance matrix is calculated with a Kalman filter operating on the set of data for the previous trip of the electric vehicle, and wherein the step of using the actual driven distance and change in battery SOC during the new trip to update the set of model parameters and the error covariance matrix comprises updating the model parameters in a discrete time model by calculating and adding to each of the model parameters a process noise of the respective parameter, as calculated by the Kalman filter.

5. The method of claim 1, wherein the error covariance matrix is calculated with a Kalman filter operating on the set of data for the previous trip of the electric vehicle.

6. The method of claim 1, wherein the set of data for the previous trip of the electric vehicle is for a previous trip having at least a minimum distance traveled or a minimum duration of travel.

7. The method of claim 1, wherein the step of applying the set of model parameters and error covariance matrix to generate an estimated end of range distance for the new trip is performed without a destination known to a control apparatus of the electric vehicle.

8. The method of claim 1 wherein the set of model parameters are the parameters a and b in the following formula:
$$Distance = a * {SOC}_{U} + b$$
wherein SOC_{U} is a usable battery charge at a start of the new trip.

9. A method of generating estimates of end of range for an electric vehicle, comprising:
obtaining a set of data for a previous trip of the electric vehicle;
estimating a set of model parameters for reduction of battery capacity relative to distance travelled, from a starting battery capacity to an end of range battery capacity using the previous trip data, by entering treating the previous trip data as inputs to a moving horizon observer;
for a new trip, applying the set of model parameters to generate an estimated end of range distance; and
displaying the estimated end of range distance to a driver of the vehicle,
wherein the displayed prediction is updated as the new trip progresses by obtaining new data from the new trip, and entering the new data in the moving horizon observer while removing oldest data from the moving horizon observer.

10. The method of claim 9, wherein the set of data for the previous trip of the electric vehicle is for a previous trip having at least a minimum distance traveled or a minimum duration of travel.

11. The method of claim 9 wherein the set of model parameters are the parameters a and b in the following formula:
$$Distance = a * {SOC}_{U} + b$$
wherein SOC_{U} is a usable battery charge at a start of the new trip.

12. The method of claim 9, further comprising recording distance, speed, and battery parameters during the new trip for use in performing the estimating and calculating steps for a subsequent trip.

13. A method of generating updated estimates of end of range for an electric vehicle, comprising:
receiving a destination for a current trip of the vehicle;
in a digital twin simulation:
generating a speed profile for the vehicle to reach the destination using a model of the vehicle, and road data for a path between a current position of the vehicle and the destination;
generating a battery charge consumption using a battery model for the vehicle to determine expected charge consumption to reach the destination or an end of range position; and
setting an end of range (EOR) reference and battery state of charge (SOC) EOR value;
communicating the EOR reference and the battery SOC EOR value to the vehicle from the digital twin;
as the vehicle traverses the path:
collecting actual distance traveled and battery state of charge measurements;
fusing the EOR reference, the battery SOC EOR value, the battery SOC measurement, and the actual distance travelled to update a model relating battery SOC to distance travelled;
estimating EOR for the vehicle in the current trip; and
displaying the estimated EOR for the vehicle in the current trip to a driver of the vehicle.

14. The method of claim 13, wherein the fusing step is performed in a Kalman filter having an R matrix, a Q matrix, and an error covariance matrix, by:
constructing a first model using the EOR reference and the battery SOC EOR value as:
$${y}_{1 , k} = a * {SOC}_{EOR} + b + {v}_{1 , k}$$
where y_{1,k} is the EOR reference, SOC_{EOR}, is the battery SOC at EOR, and v_{1,k} is a white noise defined by a variance of the Kalman filter R matrix, and a and b are model parameters;
pairing the first model with a second model of the form:
$${y}_{2 , k} = a * {SOC}_{k} + b + {v}_{2 , k}$$
where y_{2,k} is the actually driven distance at a sample, k, SOCₖ, is the battery SOC at sample k, and v_{2,k} is a white noise defined by a variance of the Kalman filter R matrix.

15. The method of claim 14, wherein the model parameters a and b are treated as constants and are updated from one sample to a next sample using formulas given by:
$${p}_{k} = {p}_{k - 1} + {w}_{p , k - 1}$$
$${b}_{k} = {b}_{k - 1} + {w}_{b , k - 1}$$
and w_{p,k-1} is the process noise of the a parameter and w_{b,k-1} is the process noise of the b parameters, each given by the Kalman filter Q matrix.

16. The method of claim 15, further comprising updating the estimated EOR for the vehicle in the current trip using the updated model parameters, and displaying to a driver of the vehicle an updated estimated EOR at least once.

17. The method of claim 15, wherein the steps of collecting, fusing, estimating and displaying are performed repeatedly at sample times as the vehicle traverses the path.

18. The method of claim 13 wherein the digital twin uses traffic data in addition to road data to generate the speed profile, and the collecting, fusing, estimating and displaying steps are performed without obtaining or using traffic or road data.

19. The method of claim 13, wherein the set of data for the previous trip of the electric vehicle is for a previous trip having at least a minimum distance traveled or a minimum duration of travel.

20. The method of claim 13, wherein the digital twin is calculated in a fleet monitor or data processing center remote from the electric vehicle.
